(19) United States
(12) Patent Application Publication
(10) Pub. No.: US 2009/0155579 A1
(43) Pub. Date: Jun. 18, 2009

(54) ELECTROSTATIC COATINGS AND ARTICLES COMPRISING POLYTHIOPHENES

(75) Inventors: Christopher Greco, Pittsburgh, PA (US); Brian Woodworth, Pittsburgh, PA (US); Shawn P. Williams, Pittsburgh, PA (US); Glenn H. Thompson, Butler, PA (US)

Correspondence Address: FOLEY AND LARDNER LLP;SUITE 500, 3000 K STREET NW, WASHINGTON, DC, 20007, US

(73) Assignee: Plextronics, Inc.

(21) Appl. No.: 12/161,546

(22) PCT Filed: Jan. 18, 2007
(86) PCT No.: PCT/US07/01245

§ 371 Date: Nov. 26, 2008

Related U.S. Application Data
(60) Provisional application No. 60/760,386, filed on Jan. 20, 2006.

(51) Int. Cl. B32B 17/10

(52) U.S. Cl. 428/336

(57) ABSTRACT

Electrostatic dissipation coatings based on regioregular polythiophenes including blends and block copolymers. The compositions can be soluble in organic solvents. Excellent film formation, transparency, stability, and conductivity control can be achieved.

### BACKGROUND

Electrostatic discharge or dissipation (ESD) is a common problem in many applications including electronic devices which are becoming smaller and more intricate. In many cases, coatings are needed which can function as electrostatic discharge coatings, particularly in fine structural applications which require a high degree of structural control. However, limitations exist for these electrostatic discharge coatings, and versatile coatings are needed which can meet specific performance requirements. Hence, a coating system is needed which is versatile and can be tuned to particular applications. Although electrically conducting polymers, sometimes also known as inherently conducting polymers (ICPs), intrinsically conducting polymers, and conjugated polymers, and the like, can be used in these applications, in many cases, they do not provide sufficient versatility. For example, in many cases, they are limited by processing and instability problems. For example, lack of solubility of the intrinsically conductive polymer may limit performance. Good coating properties can be difficult to achieve. Most systems do not allow the amount of the conducting polymer to be minimized so that it can provide the desired versatility, compatibility, and electrostatic properties needed for a given application. Many conductive polymers are insoluble in the conductive state. In some cases, Insoluble conductive polymers can be dispersed in organic solvents or compounded into plasticized coatings. However, these coatings can have generally low ICPs loading levels, limited optical transparency, and low conductivity. Better electrically conducting polymer systems are needed for electrostatic discharge coatings. In addition, good coating systems based on organic solvents (non-aqueous solvents) are needed.

For context, electrically conductive polymers are described in The Encyclopedia of Polymer Science and Engineering, Wiley, 1990, pages 298-300, including polyacetylene, poly(p-phenylene), poly(p-phenylene sulfide), polypyrrole, and polythiophene, which is hereby incorporated by reference in its entirety. This reference also describes blending and copolymerization of polymers, including block copolymer formation. Block copolymers are described in, for example, Block Copolymers, overview and Critical Survey, by Noshay and McGrath, Academic Press, 1977. For example, this text describes A-B diblock copolymers (chapter 5), A-B-A triblock copolymers (chapter 6), and -(AB)ₙ- multiblock copolymers (chapter 7).

Electrostatic applications are described in for example U.S. Pat. No. 6,099,757 (Kulkarni, Americhem). U.S. Pat. No. 6,528,572 (Patel, G E) claims block copolymer electrostatic applications.

### SUMMARY

Provided herein is a versatile polymer coating system which can be used in electrostatic discharge applications. The system is based on regioregular polythiophene. Regioregular poly(thiophenes) can offer many advantages over other ICPs in that they can have (1) high solubility, (2) good electronic properties such as high conductivity, (3) stable doping, and (4) chemical compatibility with various structural and synthetic polymers. The invention relates to among other things coated articles, coatings, methods of making, and methods of using compositions as electrostatic dissipation coatings.

For example, one embodiment provides an article comprising: at least one substrate, at least one electrostatic dissipation coating on the substrate, wherein the coating comprises at least one polymer blend comprising at least one polymer comprising regioregular polythiophene and at least one polymer which does not comprise regioregular polythiophene. The resulting ESD coating can have an optical transparency of >80% as measured by UV/Vis spectroscopy at a film thickness of 38 nm. The polymer comprising the regioregular polythiophene can be a homopolymer or a copolymer. If the polymer comprising regioregular polythiophene is a block copolymer, one segment of the block can comprise regioregular polythiophene. The degree of regioregularity can be, for example, at least 85%, or alternatively, at least 95%.

Another embodiment provides an article comprising: at least one substrate, at least one electrostatic dissipation coating on the substrate having a coating thickness of about 100 nm or less, wherein the coating comprises (1) at least one polymer blend comprising at least one polymer comprising an organic solvent soluble regioregular polythiophene which is doped, and (2) at least one organic solvent soluble polymer which does not comprise regioregular polythiophene, wherein the coating transparency is at least 80% for a coating thickness of 38 nm. The coating transparency can be at least 90% over the wavelength range of 300 nm to 800 nm. Transparency can be also measured at 525 nm.

Also provided is an article comprising: at least one substrate, at least one electrostatic dissipation coating on the substrate, wherein the coating comprises at least one block polymer comprising regioregular polythiophene and the coating, wherein the coating transparency is at least 80% for a coating thickness of 38 nm.

Another embodiment provides a coating formulated to be an electrostatic dissipation coating comprising at least one polymer blend comprising at least one polymer comprising regioregular polythiophene and at least one polymer which does not comprise regioregular polythiophene, and when dried has a transparency of at least 80% at a thickness of 38 nm.

Also provided are coating solutions or paints which can be applied to surfaces and dried.

Many important advantages can be gained including, for example, good versatility because relatively small amounts of the conducting polymer need to be present to generate sufficient conductivity. Good percolation behavior can be achieved. Moreover, good compatible blend structures can be made which show good durability, heat resistance, and water resistance, as well as good transparency. Excellent combination of properties can be achieved including for example the good combination of film formation, transparency, and good conductivity. Other conducting polymers cannot provide the same degree of versatility.

### BRIEF DESCRIPTION OF THE FIGURE

FIG. 1: Representative UV transmission spectrum of an ESD coating prepared according to working example 1A.

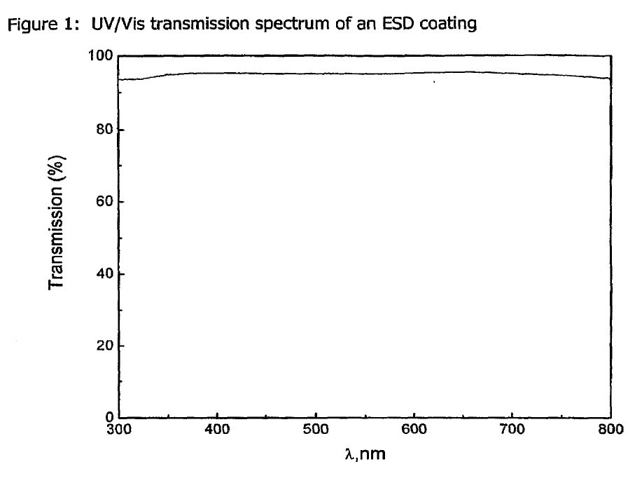

### DETAILED DESCRIPTION

All references cited herein are hereby incorporated by reference in their entirety.

One embodiment provides an article comprising: at least one substrate, at least one electrostatic dissipation coating on the substrate, wherein the coating comprises at least one polymer blend comprising at least one polymer comprising regioregular polythiophene and at least one polymer which does not comprise regioregular polythiophene. The resulting ESD coating can have an optical transparency of greater than about 80% as measured by UV/Vis spectroscopy at a coating thickness of about 38 nm. The transparency can be greater than about 90%, or greater than about 95%. The transparency value can be achieved for wavelengths covering 300 nm to 800 nm, or more particularly, 400 to 700 nm.

The substrate is not particularly limited although insulating substrates are preferred. Any surface can be used which suffers a problem with electrostatic discharge. Common solid materials can be used including glasses, metals, ceramics, polymers, composites, and the like. The shape of the substrate is not particularly limited. Other substrates include for example silicon wafers or common solid materials that have been coated with polymers, structured carbons, inorganic oxides, metals, organic or inorganic compounds as well as nano-compositions of these materials. The substrate can be an insulating substrate including glass or polymer substrate.

Electrostatic dissipation coatings are known in the art, and the coating can be formulated for the particular electrostatic dissipation application.

The electrostatic dissipation coating on the substrate can be a polymer blend comprising multiple polymer components as known in the art. For example, a first polymer component can be at least one polymer comprising regioregular polythiophene. A second polymer component can be at least one polymer which does not comprise regioregular polythiophene. The first and second polymers are different polymers. One skilled in the art knows that a particular polymer comprises a heterogeneous collection of polymer chains and yet is one polymer.

Regioregular polythiophene polymers and copolymers, including block copolymers are described for example in U.S. Pat. Nos. 6,602,974 and 6,166,172, which are hereby incorporated by reference in their entirety. The polymer comprising regioregular polythiophene can be a homopolymer or a copolymer. The copolymer can be a block copolymer, and one segment of the block can comprise regioregular polythiophene. Soluble polymers can be used, or at least polymers which are sufficiently dispersed that they function as soluble polymers.

Methods to prepare, purify, blend, formulate, dope, and put in usable form are known in the art. For example, additional regioregular polythiophene compositions, including blends, are described in for example provisional patent application 60/651,211 filed Feb. 10, 2005 to Sheina et al (Hole Injection Layer Compositions). These formulations are particularly good for thin film applications.

Additional regioregular polythiophene compositions are described in for example U.S. patent application Ser. No. 11/234,374 filed Sep. 26, 2005 on Heteroatom Regioregular Poly(3-Substitutedthiophenes) For Electroluminescent Devices” as well as in Ser. No. 11/234,373 filed Sep. 26, 2005 for Heteroatomic Regioregular Poly(3-substitutedthiophenes) for Photovoltaic Cells, which are hereby incorporated by reference in their entirety.

Additional regioregular polythiophene compositions are described in U.S. Provisional Patent Appln No. 60/661,934 for Copolymers of Soluble Poly(Thiophenes) with Improved Electronic Performance filed Mar. 15, 2005, which is hereby incorporated by reference in its entirety.

Additional regioregular polythiophene compositions are described in U.S. Provisional Patent Appln No. 60/703,890 filed Aug. 1, 2005 for Solvent Suppressed Doping of Regioregular Polythiophenes, which is hereby incorporated by reference in its entirety.

More specifically, synthetic methods, doping, and polymer characterization, including regioregular polythiophenes with side groups, are provided in, for example, U.S. Pat. Nos. 6,602,974 to McCullough et al. and 6,166,172 to McCullough et al., which are hereby incorporated by reference in their entirety. Additional description can be found in the article, “The Chemistry of Conducting Polythiophenes,” by Richard D. McCullough, Adv. Mater. 1998, 10, No. 2, pages 93-116, and references cited therein, which is hereby incorporated by reference in its entirety. Another reference which one skilled in the art can use is the Handbook of Conducting Polymers, 2^{nd} Ed. 1998, Chapter 9, by McCullough et al., “Regioregular, Head-to-Tail Coupled Poly(3-alkylthiophene) and its Derivatives,” pages 225-258, which Is hereby incorporated by reference in its entirety. This reference also describes, in chapter 29, “Electroluminescence in Conjugated Polymers” at pages 823-846, which is hereby incorporated by reference in its entirety.

Regioregular polythiophenes comprising one or more alkyleneoxy side groups per repeat unit can be used

Polythiophenes are described, for example, in Roncali, J., Chem. Rev. 1992, 92, 711; Schopf et al., Polythiophenes: Electrically Conductive Polymers, Springer: Berlin, 1997. Regioregular polythiophenes, however, offer advantages over nonregioregular polythiophenes.

Block copolymers including polythiophenes are described in, for example, Francois et al., Synth. Met. 1995, 69, 463-466, which is incorporated by reference in its entirety; Yang et al., Macromolecules 1993, 26, 1188-1190; Widawski et al., Nature (London), vol. 369, Jun. 2, 1994, 387-389; Jenekhe et al., Science 279, Mar. 20, 1998, 1903-1907; Wang et al., J. Am. Chem. Soc. 2000, 122, 6855-6861; Li et al., Macromolecules 1999, 32, 3034-3044; Hempenius et al., J. Am. Chem. Soc. 1998, 120, 2798-2804.

The degree of regioregularity can be for example at least 85%, or at least 90%, or at least 95%, or at least 99%. Methods known in the art such as for example NMR can be used to measure this.

The amount of the polymer which comprises the regioregular polythiophene can be adapted to provided the desired properties for a particular applications and can be less than about 50 wt. %, or less than about 30 wt. %, or more particularly, about 10 wt. % to about 30 wt. %, or about 20 wt. %. In general, it can be less than about 10 wt. % %, and more particularly, less than about 5 wt. %. If this polymer is a copolymer, such as a block copolymer, the amount is based on the regioregular polythiophene component only and not the other component which is not regioregular polythiophene. Here, for example, the amount of the regioregular polythiophene can be less than about 30 wt. %.

The polymer which does not comprise regioregular polythiophene can be a synthetic polymer and is not particularly limited. It can be thermoplastic. Examples include organic polymers, synthetic polymers polymer or oligomer such as a polyvinyl polymer having a polymer side group, a poly(styrene) or a poly(styrene) derivative, poly(vinyl acetate) or its derivatives, poly(ethylene glycol) or its derivatives such as poly(ethylene-co-vinyl acetate), poly(pyrrolidone) or its derivatives such as poly(1-vinylpyrrolidone-co-vinyl acetate, poly(vinyl pyridine) or its derivatives, poly(methyl methacrylate) or its derivatives, poly(butyl acrylate) or its derivatives. More generally, it can comprise of polymers or oligomers built from monomers such as CH₂CH Ar, where Ar=any aryl or functionalized aryl group, isocyanates, ethylene oxides, conjugated dienes, CH₂CHR₁R (where R₁=alkyl, aryl, or alkyl/aryl functionality and R═H, alkyl, Cl, Br, F, OH, ester, acid, or ether), lactam, lactone, siloxanes, and ATRP macroinitiators. Preferred examples include poly(styrene) and poly(4-vinyl pyridine).

The blend can be a compatible blend rather than an incompatible blend. However, the blend does not need to be a miscible blend. The phases can mix well together and provide good long term stability and structural integrity. Blends are generally known in the polymer art. See, for example, (1) Contemporary Polymer Chemistry, Allcock and Lamp, Prentice Hall, 1981, and (2) Textbook of Polymer Science, 3^{rd} Ed., Billmeyer, Wiley-Interscience, 1984. Polymer blends can be prepared by mixing two or more polymers together including binary and ternary blends. In some cases, lower molecular weight polymers or oligomers can be used but, generally, higher molecular weight, film-forming, self-supporting polymers are preferred for preparing blends. Blends can be formulated in the present invention to provide high quality thin films, coatings, or layers. The polymers can be in a variety of forms including, for example, homopolymers, copolymers, crosslinked polymers, network polymers, short chain or long chain branched polymers, interpenetrating polymer networks, and other types of mixed systems known in the polymer art. Block copolymers can be used to compatibilize the blends.

The molecular weight of the polymers in the blend is not particularly limited. For example, for the polymer comprising the regioregular polythiophene, it can be about 5,000 to about 50,000, or about 10,000 to about 25,000 for number average molecular weight.

The polymer materials can be crosslinked if desired.

The polymers can be soluble in organic solvents. Compositions can be formulated in solvents and cast as films and coatings. Known methods can be used to blend, filter, and agitate.

Doping processes known in the art can be used including organic doping and inorganic doping, as well as ambient doping. The use of an inherently conductive polymer in electrostatic applications can involve a controlled oxidation or “doping” of the polymer to obtain the desired conductive state that can improve performance. Upon oxidation, electrons are removed from the valence band. This change in oxidation state results in the formation of new energy states. The energy levels are accessible to some of the remaining electrons in the valence band, allowing the polymer to function as a conductor.

In electrostatic discharge applications, the electronic conductivity can range from about 10⁻³ S/cm to about 10⁻¹³ S/cm, but most typically it is in the range of about 10⁻⁴ S/cm to about 10⁻¹⁰ S/cm, or at least about 10⁻¹⁰ S/cm. Important characteristics of the coatings are that they retain their conductivity for thousands of hours under normal use conditions and meet suitable device stress tests at elevated temperatures and/or humidity. This facilitates an operational range of robust charge mobility and allows the tuning of properties by controlling the amount and identity of the doping species and complements the ability to tune these properties by the varying of the primary structure of the ICP.

There are many oxidants which may be used to tune conductive properties. Molecular halogens such as bromine, iodine, and chlorine offer some advantages. By controlling the amount of exposure of a polymer film to the dopant, the resulting conductivity of the thin film can be controlled. Because of their high vapor pressure and solubility in organic solvents, halogens may be applied in the gas phase or in solution. Oxidation of the polymer greatly reduces the solubility of the material relative to that of the neutral state. Nevertheless, some solutions may be prepared and coated onto devices.

Other examples include iron trichloride, gold trichloride, arsenic pentafluoride, alkali metal salts of hypochlorite, protic acids such as benzenesulfonic acid and derivatives thereof, propionic acid, and other organic carboxylic and sulfonic acids, nitrosonium salts such as NOPF₆ or NOBF₄, or organic oxidants such as tetracyanoquinone, dichlorodicyanoquinone, and hypervalent iodine oxidants such as iodosylbenzene and iodobenzene diacetate. Polymers may also be oxidized by the addition of a polymer that contains acid or oxidative or acidic functionality such as poly(styrene sulfonic acid).

Some Lewis acid oxidants such as iron trichloride, gold trichloride, and arsenic pentafluoride have been used to dope ICPs via a redox reaction. These dopants have been reported to result in the formation of stable, conductive films. This is primarily accomplished through the treatment of the cast film to a solution of the metal chloride, albeit the casting of doped films is possible but is rarely reported.

Protic organic and inorganic acids such as benzenesulfonic acid and derivatives thereof, propionic acid, other organic carboxylic and sulfonic acids, and mineral acids such as nitric, sulfuric and hydrochloric can be used to dope ICPs.

Nitrosonium salts such as NOPF₆ and NOBF₄ can be used to dope ICPs by a reaction which produces the stable nitric oxide molecule in an irreversible redox reaction.

Organic oxidants such tetracyanoquinone, dichlorodicyanoquinone, and hypervalent iodine oxidants such as iodosylbenzene and iodobenzene diacetate can also be used to dope ICPs.

These dopants may be solids, liquids, of vapors, depending upon their specific chemical properties. In some cases these dopants may form or be added as complexes with the thermoplastic component of the formulations or coatings.

Another embodiment is ambient doping, wherein the doping agent arises from oxygen, carbon dioxide, moisture, stray acid, stray base, or some other agent in the ambient air or polymer surroundings. Ambient doping can be dependent on factors such as, for example, the presence of solvent and the amounts of impurities.

Non-aqueous doping can be carried out. The non-aqueous solvent is not particularly limited, and solvents known in the art can be used. Organic solvents can be used including halogenated solvents, ketones, ethers, alkanes, aromatics, alcohols, esters, and the like. Mixtures of solvents can be used. For example, one solvent may facilitate dissolution of one component, and another solvent may facilitate dissolution of a different component. Furthermore, processing the constituents from common organic solvents leads to suppression of unwanted water-dependent side reactions, which potentially can degrade organic reagents, thereby drastically affecting device performance and shortening its lifetime. Although water is generally not favored, limited quantities of water may be present in some cases to stabilize desirable dopant properties. For example, water can be present in amounts of 5 wt % or less, 1 wt % or less, or 0.1 wt % or less. One can test the compositions to determine the impact of water at these concentrations. In addition, due to the ability of acidic components to assist in degradation, their usage is generally undesirable in some embodiments wherein acid is not desirable (Kugler, T.; Salaneck, W. R.; Rost, H.; Holmes, A. B. Chem. Phys. Lett. 1999, 310, 391).

Many polymer dissolving solvents are very hydrophilic, polar, and protic. However, In some cases, in addition to dissolving the constituents in the non-aqueous solvent (although the present invention is not limited by theory), solvents may only highly disperse one or all of the components. For example, the intrinsically conductive polymer may only be highly dispersed as opposed to forming a true solution in the non-aqueous solvent.

Homogeneously suspended solids of the ICP, both blended or copolymerized with the another polymer and the dopant, can form a non-aqueous system that can be easily processed and applied to fabrication of novel electrostatic dissipation coatings. Due to the absence of water-organic solvent interfaces, diffusional limitations of both the substrate and the other constituents can be eliminated. Furthermore, it allows one to either control the concentrations of the constituents or manipulate/adjust the ranges, or build a database of blending experiments to achieve the best electrostatic dissipation performance. For example, the ICP can be present in amounts of 0.5% to 25 wt %, the polymer which does not comprise regioregular polythiophene can be present in amounts of 0.5% to 70 wt %, and the dopant can be present in amounts of 0.5% to 5 wt %, with the solid content of 1.5% to 5 wt % in organic solvent.

### Properties

In many cases, the coatings are formulated to provide thin and/or transparent films which have good adhesion to the material to be coated. They can also be formulated to be scratch resistant, durable, and tough. The films can be formulated to retain their conducting when exposed to solvents such as water and cleaning materials including detergents. Other important properties include ease of application by spin coating, ink jetting, or roll coating processes. Film thickness can also be important, and it can be important the polymer composition is formulated to allow for thin coatings.

Transparency and conductivity measurements can be carried out by methods known in the art. Testing can be carried out on films which are separated and physically isolated from the articles upon which they coat.

### Applications

Applications include for example electronic components, semiconductor components as well as antistatic finishes for displays, projectors, aircraft or vehicular windscreens and canopies, and CRT screens. Other applications include antistatic floor waxes and finishes, ESD coatings for aircraft bodies, ESD coatings for carpet fibers and fabrics, and the like.

The following non-limiting working examples further illustrate the invention.

### WORKING EXAMPLES

### Example 1A

### Formulation of an ESD Coating

60 mg of Plexcore MP, a soluble regioregular polythiophene available from Plextronics, Pittsburgh, Pa., was dissolved in 7.44 g of DMF by heating and stirring. The solution was vigorously agitated for 30 minutes. 57 mg of paratoluenesulfonic acid was added, and the solution was vigorously agitated again for 30 minutes. 210 mg of poly(4-vinylpyridine) was dissolved in 7.23 g DMF and vigorously agitated for 30 minutes. The two solutions were combined and vigorously agitated for 30 minutes. The solution was passed through a 0.45 micron syringe filter. 17 mg of dichlorodicyanoquinone dissolved in 0.1 mL of DMF was injected into the mixture with a syringe.

### Example 1B

### Formulation of an ESD Coating

60 mg of soluble regioregular polythiophene was dissolved in 7.44 g of DMF by heating and stirring. The solution was vigorously agitated for 30 minutes. 44 mg of para-toluenesulfonic acid was added and the solution was vigorously agitated again for 30 minutes. 210 mg of poly(4-vinylpyridine) was dissolved in 7.25 g DMF and vigorously agitated for 30 minutes. The two solutions were combined and vigorously agitated for 30 minutes. The solution was passed through a 0.45 micron syringe filter. 13 mg of dichlorodicyanoquinone dissolved in 0.1 mL of DMF was injected into the mixture with a syringe.

### Example 2

### Application of Coating

Films were prepared by spin casting onto ozone treated glass substrates. The films were spun at 350 rpm for 5 seconds to spread, and 2000 rpm for 60 seconds to thin with a ramp of 1275. The films were annealed at temperatures ranging from 80-170° C. for 10-40 minutes, but films were typically annealed at 110° C. for 10 minutes. Typical film thicknesses observed were about 40 nm.

### Example 3

### Data

| | Thickness | % | | |
|---|---|---|---|---|
| | (nm)¹ | Transmission² | R (Ω/□)³ | σ (S/cm)⁴ |
| Example 1A | 37 | >90 | 3.08E9 | 8.78E−5 |
| Example 1B | 38 | 95 | 2.05E9 | 1.28E−4 |
| Uncoated Glass | — | 100 | 8.6E13 | Not applicable |

¹Thickness was measured by a profilometer (Veeco Instruments, Model Dektak 8000) and reported as the average of three readings.
²% Transmission is measured relative to the uncoated glass substrate which is assigned to equal 100%.
³Resistivity is reported in units of Ohms/square and is measured by a concentric ring (Prostat Corporation, Model PRS-812) and reported as the average of three readings.
⁴Conductivity is reported in siemens/cm and is calculated by 1/(resistivity (ohms/square) * Thickness (cm)).

What is claimed is:

1. An article comprising:
at least one substrate,
at least one electrostatic dissipation coating on the substrate, wherein the coating comprises at least one polymer blend comprising at least one polymer comprising regioregular polythiophene and at least one polymer which does not comprise regioregular polythiophene, wherein the coating transparency is at least 80% for a coating thickness of 38 nm.

2. The article according to claim 1, wherein the polymer comprising regioregular polythiophene is a homopolymer.

3. The article according to claim 1, wherein the polymer comprising regioregular polythiophene is a copolymer.

4. The article according to claim 1, wherein the polymer comprising regioregular polythiophene is a block copolymer, and one segment of the block comprises regioregular polythiophene.

5. The article according to claim 1, wherein the regioregular polythiophene has a degree of regioregularity of at least 85%.

6. The article according to claim 1, wherein the regioregular polythiophene has a degree of regioregularity of at least 95%.

7. The article according to claim 1, wherein the amount of the regioregular polythiophene is less than about 30 wt. %.

8. The article according to claim 1, wherein the blend is a compatible blend.

9. The article according to claim 1, wherein the polymer which does not comprise regioregular polythiophene is a synthetic polymer.

10. The article according to claim 1, wherein the at least one polymer comprising regioregular polythiophene and at least one polymer which does not comprise regioregular polythiophene are each soluble in organic solvent.

11. The article according to claim 1, wherein the at least one polymer comprising regioregular polythiophene is doped sufficiently to provide an electronic conductivity of at least about 10⁻¹⁰ siemens/cm.

12. The article according to claim 1, wherein the electronic conductivity of the coating is about 10⁻¹³ siemens/cm to about 10⁻³ siemens/cm.

13. The article according to claim 1, wherein the substrate is an insulative substrate.

14. The article according to claim 1, wherein the substrate comprises glass, silica, or a polymer.

15. The article according to claim 1, wherein the regioregular polythiophene is doped with an organic dopant and is substituted with a heteroatom.

16. The article according to claim 1, wherein the regioregular polythiophene is doped with a quinone compound and the coating has a thickness of about 10 nm to about 100 nm, and wherein the polymer which does not comprise regioregular polythiophene comprises a polystyrene, a polystyrene derivative, a polyurethane, a polyacrylate, a polypyridine, or a polyvinyl phenol.

17. The article according to claim 1, wherein the transparency is at least 90% over the wavelength region of 300 nm to 800 nm.

18. An article comprising:
at least one substrate,
at least one electrostatic dissipation coating on the substrate having a coating thickness of about 100 nm or less, wherein the coating comprises (1) at least one polymer blend comprising at least one polymer comprising an organic solvent soluble regioregular polythiophene which is doped, and (2) at least one organic solvent soluble polymer which does not comprise regioregular polythiophene, wherein the coating transparency is at least 80% for a coating thickness of 38 nm.

19. The article according to claim 18, wherein the coating transparency is at least 90% over the wavelength range of 300 nm to 800 nm.

20. An article comprising:
at least one substrate,
at least one electrostatic dissipation coating on the substrate, wherein the coating comprises at least one polymer comprising regioregular polythiophene and the coating, wherein the coating transparency is at least 80% for a coating thickness of 38 nm.

21. The article according to claim 20, wherein the polymer is a block copolymer.
